(19) United States
(12) Patent Application Publication
(10) Pub. No.: US 2023/0221443 A1
(43) Pub. Date: Jul. 13, 2023

(54) Assembly Unit Of A Vehicle With Lidar Sensor

(71) Applicant: Joynext GmbH, Dresden (DE)

(72) Inventor: Lars Franke, Dresden (DE)

(21) Appl. No.: 17/747,050

(22) Filed: May 18, 2022

(30) Foreign Application Priority Data
Jan. 12, 2022 (DE) 102022100594.1

(51) Int. Cl. G01S 17/931; G01S 7/481; H01Q 1/32

(52) U.S. Cl. CPC G01S 17/931; G01S 7/4811; H01Q 1/3275

(57) ABSTRACT

The invention relates to an assembly unit (100) arranged on a roof (201) of a vehicle. The assembly unit (100) comprises a radio antenna unit (101) arranged above the vehicle roof (201) and having at least one radio antenna (107) which is adapted to transmit and receive radio signals, a lidar sensor (102) arranged below the radio antenna unit (101) and above the vehicle roof (201) and adapted to detect objects around the vehicle, and a first cooling unit (103) arranged below the lidar sensor (102).

The invention relates to an assembly unit of a vehicle with a lidar sensor.

### BACKGROUND

Vehicles are increasingly being equipped with sensors set up to detect objects in a vehicle's environment. The measurement signals from these sensors are used in particular in driver assistance systems such as proximity control systems, lane departure warning systems, lane change assistants or collision warning systems. In particular, these sensors also play a central role in autonomous driving.

Lidar sensors (Lidar: abbreviation for light detection and ranging) are particularly important in this context, as they enable very precise object detection with a higher angular and distance resolution than other sensors such as cameras or radar sensors.

A lidar sensor emits laser beams, in particular laser pulses, and detects laser radiation reflected or backscattered by an object to the lidar sensor. The distance of the object from the lidar sensor is determined from the duration between the emission of a laser pulse and the reception of the reflected or backscattered laser radiation. By laser scanning, i.e. by swiveling the emitted laser radiation or by changing the direction of the emitted laser radiation, an environment of the lidar sensor can be detected (“scanned”) in two or three dimensions.

There are lidar sensors that swivel the laser radiation they emit only within a certain angular range, and lidar sensors that swivel the laser radiation they emit over an entire angular range of 360 degrees around the lidar sensor.

In addition, vehicles are increasingly being equipped with radio units that have radio antennas for transmitting and/or receiving radio signals. Such radio units are, for example, mobile radio units for transmitting and receiving mobile radio signals, WLAN radio units for transmitting and receiving WLAN radio signals (WLAN: abbreviation for Wireless Local Area Network), Bluetooth radio units for transmitting and receiving Bluetooth radio signals, and radio units for receiving satellite signals from navigation satellites of navigation satellite systems such as GPS, GLONASS, Beidou or Galileo.

In particular, so-called V2V communication and V2X communication via radio signals are becoming increasingly important. V2V communication is the exchange of information and data between two vehicles by means of radio signals that are transmitted by a transmitter unit of one vehicle and received by a receiver unit of the other vehicle. V2V communication between vehicles is also referred to as vehicle-to-vehicle communication, C2C communication or car-to-car communication. V2X communication is more generally understood as the exchange of information and data between a vehicle and an environment of the vehicle. V2X communication is also referred to as vehicle-to-anything communication, car2X communication, or car-to-X communication.

The radio signals of V2V and V2X communication are exchanged between the participants, for example, with ITS-G5/DSRC (DSRC: abbreviation for Dedicated Short Range Communication) or in a mobile radio network, for example, via PC5 or Uu interfaces.

### SUMMARY

The invention is based on the task of providing an improved assembly unit with a lidar sensor for a vehicle.

According to the invention, the task is solved with a assembly unit which is arranged at a roof of a vehicle. The unit comprises
a radio antenna unit arranged above the vehicle roof and having at least one radio antenna which is set up for transmitting and receiving radio signals,
a lidar sensor which is arranged below the radio antenna unit and above the vehicle roof and is set up for detecting objects in an environment of the vehicle, and
a first cooling unit arranged below the lidar sensor.

According to the invention, a radio antenna unit and a lidar sensor are thus arranged together with a first cooling unit in an assembly unit on a vehicle roof of a vehicle. The radio antenna unit and the lidar sensor are arranged above the vehicle roof, with the radio antenna unit being arranged above the lidar sensor.

The arrangement of the radio antenna unit above the vehicle roof advantageously enables radio signals to be transmitted with the radio antenna unit largely uniformly and undisturbed in all directions, especially if the assembly unit is arranged approximately in the center of the vehicle roof.

The arrangement of the lidar sensor above the vehicle roof makes it possible in particular to detect objects in an angular range of 360 degrees around the vehicle with the lidar sensor if the lidar sensor is designed accordingly. This is generally not possible with an arrangement of the lidar sensor other than above the vehicle roof, since components of the vehicle itself are then in the way of the laser beams emitted by the lidar sensor in at least one angular range.

Of course, it would be possible to scan the entire 360-degree angular range around the vehicle using multiple lidar sensors, each scanning only a limited angular range. However, this would increase the number of lidar sensors and would also require combining the measurement signals of the individual lidar sensors. However, such a combination of the measurement signals of several lidar sensors requires a high computational effort, since the measurement signals of the individual lidar sensors have to be combined in real time at high driving speeds of the vehicle in order to enable a time-accurate detection of the entire environment of the vehicle. Such a combination of the measurement signals of several lidar sensors in real time is also prone to errors and therefore less suitable, in particular for safety-related evaluations of the measurement signals, than a scan of the entire angular range of 360 degrees around the vehicle by a single lidar sensor.

The combination of the radio antenna unit and the lidar sensor in one unit also reduces the number of components arranged on the vehicle roof compared with a separate arrangement of the radio antenna unit and the lidar sensor on the vehicle roof. On the one hand, this reduces the installation effort for the radio antenna unit and the lidar sensor, and on the other hand, the aerodynamics of the vehicle can be improved compared to a separate arrangement of the radio antenna unit and the lidar sensor.

The first cooling unit enables cooling of the lidar sensor. This is advantageous because the lidar sensor on the vehicle roof can be exposed to high temperatures, especially due to solar radiation, which can impair the function of the lidar sensor if the lidar sensor is not cooled. For example, high temperatures can shift the wavelength of the laser beams generated by the lidar sensor. Therefore, cooling of a lidar sensor located on the vehicle roof is essential for its functional reliability.

In one embodiment of the invention, the assembly unit has a control unit arranged below the vehicle roof, which is set up to process sensor signals detected with the lidar sensor and/or radio signals received with the radio antenna unit.

Thus, in the aforementioned embodiment of the invention, the assembly unit comprises, in addition to the radio antenna unit and the lidar sensor, a control unit arranged under the vehicle roof, with which sensor signals detected by the lidar sensor and/or radio signals received with the radio antenna unit can be processed. The arrangement of the control unit under the vehicle roof takes into account that current and future mobile radio standards require a control unit connected to the radio antenna unit to be arranged in the vicinity of the radio antenna unit, since connecting the radio antenna unit to the control unit by coaxial cables over long distances would attenuate the radio signals too much. Up to now, on the other hand, a control unit connected to a radio antenna unit located on the vehicle roof via coaxial cables has usually been located in another area of the vehicle, for example under a seat of the vehicle.

Furthermore, the aforementioned embodiment of the invention enables processing or preprocessing of sensor signals detected with the lidar sensor and/or radio signals received with the radio antenna unit already by the control unit of the assembly unit. The processed sensor signals and/or radio signals can then be transmitted to other components of the vehicle.

In another embodiment of the invention, the control unit has a radio module that is set up to modulate radio signals to be transmitted with the radio antenna unit and/or process radio signals received with the radio antenna unit.

For example, the radio module has a transceiver for the radio antenna unit and a microcontroller for controlling the transceiver. The radio module controls the radio antenna unit and executes the transmission and reception protocol for transmitting and receiving radio signals with the radio antenna unit.

In another embodiment of the invention, the control unit has an interface to a control system of the vehicle.

The aforementioned embodiment of the invention enables the radio antenna unit and the lidar sensor to be connected to a control system of the vehicle via an interface of the control unit. For example, sensor signals detected by the lidar sensor and/or radio signals received by the radio antenna unit can thereby be supplied to the control system of the vehicle, optionally after processing or preprocessing by the control unit. Furthermore, the control unit of the assembly unit can be addressed from the control system of the vehicle via its interface to the control system of the vehicle. The interface of the control unit to the vehicle's control system is, for example, an interface to a CAN bus of the vehicle (CAN: abbreviation for Controller Area Network).

In another embodiment of the invention, the control unit comprises at least one further radio antenna for transmitting and receiving radio signals.

For example, the control unit can have a Bluetooth antenna, a WLAN antenna and/or a receiving antenna for satellite signals from navigation satellites of a navigation satellite system such as GPS, GLONASS, Beidou or Galileo as a further radio antenna. This allows the control unit to be used for transmitting and/or receiving further radio signals.

In a further embodiment of the invention, the first cooling unit is arranged to cool the lidar sensor and/or the control unit. This takes into account that the control unit may also be exposed to high temperatures due to its location under the vehicle roof, which may affect the function of the control unit. Therefore, cooling of the control unit is also required. Since the assembly unit has the first cooling unit anyway, this cooling unit is preferably also used to cool the control unit.

For example, the first cooling unit has a heat-emitting surface and/or a thermal contact surface to the vehicle roof. This enables passive cooling of the lidar sensor and/or the control unit.

In a further embodiment of the invention, the first cooling unit comprises liquid cooling circuit and/or at least one fan and/or at least one Peltier element for active cooling. A fan of the first cooling unit is arranged, for example, for flowing air through the lidar sensor and/or the control unit or through a heat sink that is in thermal contact with the lidar sensor and/or the control unit. A liquid cooling circuit of the first cooling unit is arranged, for example, for cooling the lidar sensor and/or the control unit or a heat sink in thermal contact with the lidar sensor and/or the control unit with a cooling liquid, for example with water. For example, a Peltier element of the first cooling unit is arranged to cool the lidar sensor and/or the control unit or a heat sink in thermal contact with the lidar sensor and/or the control unit. In this case, the liquid cooling circuit and/or the at least one fan and/or the at least one Peltier element are operated, for example, in a temperature-controlled manner as required.

In particular, the aforementioned embodiment of the invention enables the lidar sensor and/or the control unit to be actively cooled as needed. For example, the first cooling unit is set up to actively cool the lidar sensor if a temperature of the lidar sensor or of a vehicle component in the vicinity of the lidar sensor, for example a temperature of the vehicle roof, exceeds a pre-determinable first threshold value. Accordingly, the first cooling unit is arranged, for example, to actively cool the control unit when a temperature of the control unit or a vehicle component in the vicinity of the control unit, for example a temperature of the vehicle roof, exceeds a pre-determinable second threshold value, wherein the second threshold value may be different from the first threshold value. Alternatively or additionally, the first cooling unit is arranged, for example, to control or regulate a coolant flow of a coolant with which the lidar sensor and/or the control unit can be cooled as a function of a temperature of the lidar sensor and/or the control unit or of a vehicle component in the vicinity of the lidar sensor and/or the control unit, for example as a function of a temperature of the vehicle roof. For these purposes, the temperature of the lidar sensor and/or the control unit or the vehicle component is detected, for example, with a temperature sensor.

In a further embodiment of the invention, the lidar sensor is arranged to detect objects in a plane perpendicular to a vertical axis of the vehicle. Preferably, the lidar sensor is set up to detect objects in the plane in an angular range of 360 degrees around the vehicle.

In another embodiment of the invention, the assembly comprises a second cooling unit arranged between the radio antenna unit and the lidar sensor and adapted to cool the lidar sensor and/or the radio antenna unit.

On the one hand, the aforementioned embodiment of the invention enables the lidar sensor to be additionally cooled by a second cooling unit arranged above the lidar sensor. On the other hand, this embodiment of the invention also enables the radio antenna unit to be cooled by the second cooling unit.

For example, the second cooling unit is set up to passively cool the lidar sensor and/or the radio antenna unit.

For example, the second cooling unit has a heat sink with cooling fins that is in thermal contact with the lidar sensor and/or the radio antenna unit and is flowed with air by the airstream and thus cooled while the vehicle is moving. Such passive cooling of the lidar sensor can advantageously reduce active cooling power and energy consumption of the first cooling unit for cooling the lidar sensor.

Alternatively or additionally, the second cooling unit comprises a liquid cooling circuit and/or at least one fan and/or at least one Peltier element for active cooling.

The aforementioned embodiment of the invention enables in particular and demand-dependent, the temperature-controlled cooling of the lidar sensor and/or the radio antenna unit by means of the second cooling unit.

### BRIEF DESCRIPTION OF THE DRAWINGS

Embodiments of the invention are explained in more detail below with reference to drawings. Thereby show:

FIG. 1 a block diagram of an embodiment of a assembly unit according to the invention,

FIG. 2 schematically shows an arrangement of the unit on a vehicle roof.

Corresponding parts are marked with the same reference numbers in the figures.

### DETAILED DESCRIPTION OF EXAMPLE EMBODIMENTS

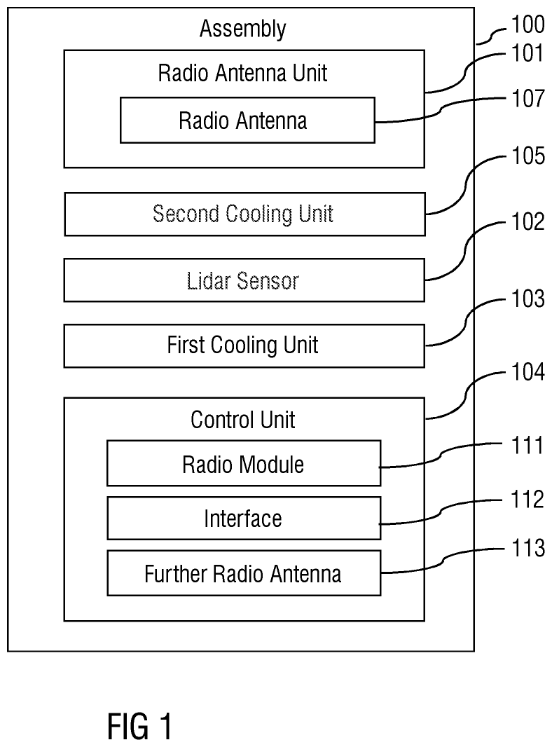

FIG. 1 shows a block diagram of an assembly unit 100 according to one embodiment of the invention. The assembly unit 100 has the following functional units, which are shown in FIG. 1: a radio antenna unit 101, a lidar sensor 102, a first cooling unit 103, a control unit 104 and a second cooling unit 105. Furthermore, the assembly unit 100 may have further functional units, which are not shown in the figures, for example one temperature sensor or several temperature sensors.

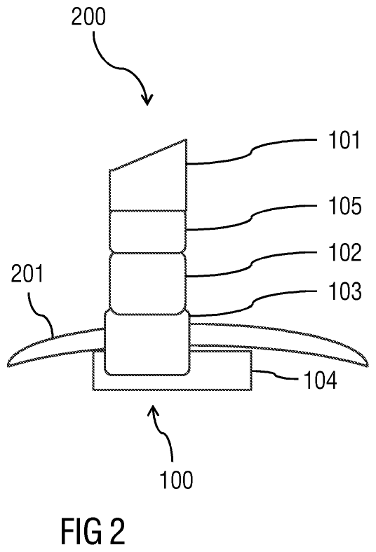

The assembly 100 is arranged at a roof 201 (see FIG. 2) of a vehicle.

FIG. 2 schematically shows an arrangement 200 of the assembly 100 at the vehicle roof 201 in a sectional view.

The radio antenna unit 101 is arranged above the vehicle roof 201 and comprises at least one radio antenna 107, which is arranged to transmit and receive radio signals. For example, the radio antenna unit 101 has a mobile radio antenna as a radio antenna 107.

The radio antenna unit 101 has, for example, a so-called sharkfin housing indicated in FIG. 2, which has the shape of a shark fin. In this way, in particular, an aerodynamically favorable shape of the radio antenna unit 101 and thus also of the assembly unit 100 can be realized.

The lidar sensor 102 is arranged below the radio antenna unit 101 and above the vehicle roof 201, and is arranged to detect objects in a surrounding area of the vehicle.

In particular, the lidar sensor 102 is arranged to detect objects in a plane perpendicular to a vertical axis of the vehicle. Preferably, the lidar sensor is thereby arranged to detect objects in the plane in an angular range of 360 degrees around the vehicle.

The first cooling unit 103 is arranged below the lidar sensor 102. The first cooling unit 103 is set up to cool the lidar sensor 102 and the control unit 104.

In particular, the first cooling unit 103 may be arranged to actively cool the lidar sensor 102 and the control unit 104 as needed. For example, the first cooling unit 103 is arranged to actively cool the lidar sensor 102 when a temperature of the lidar sensor 102 or a vehicle component in the vicinity of the lidar sensor 102, for example a temperature of the vehicle roof 201, exceeds a predetermined first threshold value. Alternatively or additionally, the first cooling unit 103 is arranged, for example, to control or regulate a coolant flow of a coolant with which the lidar sensor 102 is coolable in dependence on a temperature of the lidar sensor 102 or a vehicle component in the vicinity of the lidar sensor 102, for example in dependence on a temperature of the vehicle roof 201. For example, the first cooling unit 103 is adapted to maintain the temperature of the lidar sensor 102 below 125° C., preferably below 100° C., preferably below 75° C.

Accordingly, the first cooling unit 103 is arranged, for example, to actively cool the control unit 104 when a temperature of the control unit 104 or a vehicle component in the vicinity of the control unit 104, for example a temperature of the vehicle roof 201, exceeds a predetermined second threshold value. Alternatively or additionally, the first cooling unit 103 is arranged, for example, to control or regulate a coolant flow of a coolant with which the control unit 104 is coolable in dependence on a temperature of the control unit 104 or a vehicle component in the vicinity of the control unit 104, for example in dependence on a temperature of the vehicle roof 201. For example, the first cooling unit 103 is adapted to maintain the temperature of the control unit 104 below 120° C., preferably below 100° C., preferably below 75° C.

For active cooling of the lidar sensor 102, the first cooling unit 103 has, for example, a fan that is set up to flow air through the lidar sensor 102 or a heat sink that is in thermal contact with the lidar sensor 102. Alternatively or additionally, the first cooling unit 103 comprises, for example, a liquid cooling circuit for the lidar sensor 102 or a heat sink in thermal contact with the lidar sensor 102 with a cooling liquid, for example water. Alternatively or additionally, the first cooling unit 103 comprises, for example, a Peltier element arranged to cool the lidar sensor 102 or a heat sink in thermal contact with the lidar sensor 102.

Accordingly, the first cooling unit 103 for actively cooling the control unit 104 has, for example, a fan that is set up to flow air through the control unit 104 or a heat sink that is in thermal contact with the control unit 104. In this regard, a different fan may be used for cooling the control unit 104 than for cooling the lidar sensor 102, for example. Alternatively or additionally, the first cooling unit 103 comprises, for example, a liquid cooling circuit for the control unit 104 or a heat sink in thermal contact with the control unit 104 with a cooling liquid, for example water. In this regard, a different liquid cooling system may be used for cooling the control unit 104 than for cooling the lidar sensor 102, for example. Alternatively or additionally, the first cooling unit 103 comprises, for example, a Peltier element arranged to cool the control unit 104 or a heat sink in thermal contact with the control unit 104. In this regard, a different Peltier element may be used for cooling the control unit 104 than for cooling the lidar sensor 102, for example.

For temperature-dependent cooling of the lidar sensor 102 and the control unit 104, the assembly 100 may further comprise at least one temperature sensor configured to sense a temperature of the lidar sensor 102 or a vehicle component in vicinity of the lidar sensor 102 or a temperature of the control unit 104 or a vehicle component in vicinity to the control unit 104.

Furthermore, the first cooling unit 103 may also be arranged for passively cooling the lidar sensor 102 and/or the control unit 104. For example, for this purpose, the first cooling unit 103 has a heat-emitting surface arranged above the vehicle roof 201 and/or a thermal contact surface to the vehicle roof 201.

The control unit 104 is arranged below the first cooling unit 103 and below the vehicle roof 201.

In particular, the control unit 104 is arranged to process sensor signals detected with the lidar sensor 102 and/or radio signals received with the radio antenna unit 101.

For example, the control unit 104 includes a radio module 111 configured to modulate radio signals to be transmitted with the radio antenna unit 101 and/or process radio signals received with the radio antenna unit 101.

For example, the radio module 111 has a transceiver for the radio antenna unit 101 and a microcontroller for controlling the transceiver. The radio module 111 controls the radio antenna unit 101 and executes the transmission and reception protocol for transmitting and receiving radio signals with the radio antenna unit 101.

Further, the control unit 104 includes, for example, an interface 112 to a control system of the vehicle.

For example, sensor signals detected by the lidar sensor 102 and/or radio signals received by the radio antenna unit 101 can be supplied to the control system of the vehicle via the interface 112, possibly after processing or preprocessing by the control unit 104. Furthermore, the control unit 104 can be addressed via its interface 112 to the control system of the vehicle, for example, from the control system of the vehicle. The interface 112 of the control unit 104 to the control system of the vehicle is, for example, an interface to a CAN bus of the vehicle.

Further, the control unit 104 includes, for example, another radio antenna 113 for transmitting and receiving radio signals.

For example, the control unit 104 may have as a further radio antenna 113 a Bluetooth antenna, a WLAN antenna, and/or a receiving antenna for satellite signals from navigation satellites of a navigation satellite system such as GPS, GLONASS, Beidou, or Galileo. This allows the control unit 104 to be used for transmitting and/or receiving further radio signals.

The second cooling unit 105 is disposed between the radio antenna unit 101 and the lidar sensor 102, and is arranged to cool the lidar sensor 102.

For example, the second cooling unit 105 has a heat sink with cooling fins, which is in thermal contact with the lidar sensor 102 and is flowed with air by the airstream and thereby cooled while the vehicle is moving. Such passive cooling of the lidar sensor can advantageously reduce an active cooling power and an energy consumption of the first cooling unit 101 for cooling the lidar sensor 102.

Further, the second cooling unit 105 may also be configured to cool the radio antenna unit 101.

For example, if the second cooling unit 105 includes a heat sink with cooling fins, the heat sink may also be in thermal contact with the radio antenna unit 101 to passively cool the radio antenna unit 101.

Alternatively or additionally, the second cooling unit 105 is arranged for actively cooling the lidar sensor 102 and/or the radio antenna unit 101. For example, the second cooling unit 105 comprises for this purpose a liquid cooling circuit and/or at least one fan and/or at least one Peltier element for active cooling of the lidar sensor 102 and/or the radio antenna unit 101, in particular for demand-dependent and temperature-controlled cooling of the lidar sensor 102 and/or the radio antenna unit 101.

### LIST OF REFERENCE NUMBERS

100 Assembly
101 Radio antenna unit
102 Lidar sensor
103 First cooling unit
104 Control unit
105 Second cooling unit
107 Radio antenna
111 Radio module
112 Interface
113 Further radio antenna
200 Arrangement
201 Vehicle roof

1. Assembly unit (100) arranged at a vehicle roof (201) of a vehicle, comprising:
a radio antenna unit (101) arranged above the vehicle roof (201) and having at least one radio antenna (107) which is set up for transmitting and receiving radio signals,
a lidar sensor (102) arranged below the radio antenna unit (101) and above the vehicle roof (201) and adapted to detect objects around the vehicle, and
a first cooling unit (103) arranged below the lidar sensor (102).

2. The assembly unit (100) according to claim 1, further comprising a control unit (104) arranged below the vehicle roof (201), which is set up to process sensor signals detected with the lidar sensor (102) and/or radio signals received with the radio antenna unit (101).

3. The assembly unit (100) according to claim 1, wherein the control unit (104) comprises a radio module (111), which is adapted for modulating radio signals to be transmitted with the radio antenna unit (101) and/or processing radio signals received with the radio antenna unit (101).

4. The assembly unit (100) according to claim 1, wherein the control unit (104) comprises an interface (112) to a control system of the vehicle.

5. The assembly unit (100) according to claim 1, wherein the control unit (104) comprises at least one further radio antenna (113) for transmitting and receiving radio signals.

6. The assembly unit (100) according to claim 1, wherein the first cooling unit (103) is adapted for cooling the lidar sensor (102) and/or the control unit (104).

7. The assembly unit (100) according to claim 1, wherein the first cooling unit (103) comprises a heat-emitting surface and/or a thermal contact surface to the vehicle roof (201).

8. The assembly unit (100) according to claim 1, wherein the first cooling unit (103) comprises a liquid cooling circuit and/or at least one fan and/or at least one Peltier element for active cooling.

9. The assembly (100) according to claim 8, wherein the liquid cooling circuit and/or the at least one fan and/or the at least one Peltier element are temperature controlled.

10. The assembly (100) according to claim 1, wherein the lidar sensor (102) is arranged to detect objects in a plane perpendicular to a vertical axis of the vehicle.

11. The assembly unit (100) according to claim 1, comprising a second cooling unit (105) arranged between the radio antenna unit (101) and the lidar sensor (102) and adapted to cool the lidar sensor (102) and/or the radio antenna unit (101).

12. The assembly unit (100) according to claim 1, wherein the second cooling unit (105) comprises a liquid cooling circuit and/or at least one fan and/or at least one Peltier element for active cooling.
